(19) United States
(12) Patent Application Publication
(10) Pub. No.: US 2024/0328991 A1
(43) Pub. Date: Oct. 3, 2024

(54) GAS SENSOR OPERATING METHOD AND CONCENTRATION MEASUREMENT APPARATUS

(71) Applicant: NGK INSULATORS, LTD., Nagoya-shi (JP)

(72) Inventors: Naoya SAITO, Edogawa-ku (JP); Kazuki TAKEGAWA, Nagoya-shi (JP); Shodai HIRATA, Nagoya-shi (JP); Yusuke FUJII, Nagoya-shi (JP)

(21) Appl. No.: 18/615,469

(22) Filed: Mar. 25, 2024

(30) Foreign Application Priority Data
Mar. 29, 2023 (JP) 2023-053680

(51) Int. Cl. G01N 27/406; G01N 27/409; G01N 27/41

(52) U.S. Cl. CPC G01N 27/4067; G01N 27/409; G01N 27/41

(57) ABSTRACT

In a state where a sensor element heated by a heater part with a heater element being energized according to a predetermined duty ratio is at a normal drive temperature, the duty ratio is monitored, when reduction of the duty ratio from a normal value corresponding to the normal drive temperature is detected, the duty ratio is further reduced to reduce a temperature of the sensor element to a protective drive temperature, and the duty ratio is increased at a timing when a predetermined protective drive time has elapsed to return the temperature of the sensor element to the normal drive temperature, and, when the duty ratio at a timing when the temperature of the sensor element is returned to the normal drive temperature is smaller than the normal value, the duty ratio is reduced again to reduce the temperature of the sensor element to the protective drive temperature.

### CROSS-REFERENCE TO RELATED APPLICATION

The present application claims priority from Japanese Application JP2023-053680, filed on Mar. 29, 2023, the content of which is hereby incorporated by reference into this application.

### BACKGROUND OF THE INVENTION

### Field of the Invention

The present invention relates to a gas sensor operating method of operating a gas sensor disposed on an exhaust pipe of an internal combustion engine and, in particular, to temperature control of a gas sensor used in the presence of oxygen and hydrogen.

### Description of the Background Art

In terms of securement and maintenance of environmental performance of a gasoline vehicle, there is a need to know the amount of NOx and ammonia (NH₃) emitted downstream from a catalytic unit including a three-way catalyst (TWC) and a gasoline particulate filter (GPF) along an exhaust path of an engine accurately and over time. NOx is emitted in a case where an atmosphere in the TWC is a lean atmosphere, and NH₃ is emitted in a case where the atmosphere in the TWC is a rich atmosphere. Knowing the amount of emitted NOx and NH₃ allows for determination of a degree of deterioration of the catalytic unit.

Use of a NOx sensor attached to an exhaust path of a gasoline engine is already known (see Japanese Patent Application Laid-Open No. 2021-113770 and Japanese Patent Application Laid-Open No. 2021-148612, for example).

Detection of NH₃ using a gas sensor capable of detecting NOx as disclosed in Japanese Patent Application Laid-Open No. 2021-113770 and Japanese Patent Application Laid-Open No. 2021-148612 is also already known (see Japanese Patent Application Laid-Open No. 2022-091669, for example).

The use of the above-mentioned gas sensor capable of detecting NOx and ammonia to know the amount of emitted NOx and ammonia is desired also for an exhaust path of a hydrogen engine vehicle.

While oxygen and hydrogen coexist along the exhaust path of the hydrogen engine vehicle, it is widely known that hydrogen explosions occur in a case where oxygen and hydrogen are in predetermined concentration ranges, and hydrogen combusts spontaneously when being at a high temperature of more than 500° C. in the air.

In a case where a gas sensor as disclosed in Japanese Patent Application Laid-Open No. 2021-113770, Japanese Patent Application Laid-Open No. 2021-148612, and Japanese Patent Application Laid-Open No. 2022-091669 is attached to the exhaust path of the hydrogen engine vehicle and used, thermal stress caused by a rapid reaction of oxygen and hydrogen coexisting in the gas sensor might affect a sensor element depending on an operating condition of the gas sensor, resulting in cracking of the sensor element.

### SUMMARY

The present invention relates to a gas sensor operating method of operating a gas sensor disposed on an exhaust pipe of an internal combustion engine and, in particular, to temperature control of a gas sensor used in the presence of oxygen and hydrogen.

According to the present invention, a gas sensor includes: a sensor element configured to be capable of identifying a concentration of a predetermined gas component contained in a measurement gas; and a protective cover into which the measurement gas is introduced. The sensor element includes: a base part formed of an oxygen-ion conductive solid electrolyte; and a heater part including a heater element on a side of one end portion of the sensor element and heating the sensor element by the heater element being energized according to a duty ratio, and a portion of the sensor element on a side of the one end portion protrudes into the protective cover.

The gas sensor operating method includes: a) causing the heater part to heat the sensor element to a predetermined normal drive temperature and putting the gas sensor into a drive state in which the predetermined gas component is measurable; b) monitoring the duty ratio for use in the heater part; and c) controlling a temperature of the sensor element based on the temperature of the sensor element and a value of the duty ratio obtained in the step b), and, in the step c), when reduction of the duty ratio from a normal value corresponding to the normal drive temperature is detected in the step b) with the sensor element being at the normal drive temperature, the duty ratio is further reduced to reduce the temperature of the sensor element to a predetermined protective drive temperature, the duty ratio is increased at a timing when a predetermined protective drive time has elapsed after reduction of the temperature of the sensor element to the protective drive temperature, thereby to return the temperature of the sensor element from the protective drive temperature to the normal drive temperature, and when the duty ratio at a timing when the temperature of the sensor element is returned to the normal drive temperature is smaller than the normal value, the duty ratio is reduced again to reduce the temperature of the sensor element to the protective drive temperature.

According to the present invention, even in a case where the measurement gas in which gas species that can cause an exothermic reaction, such as oxygen and hydrogen, coexist is introduced into the gas sensor, cracking of the sensor element of the gas sensor occurring due to thermal stress caused by the exothermic reaction can be avoided.

It is thus an object of the present invention to provide a gas sensor operating method allowing for suitable use of a gas sensor even under an environment in which a measurement gas in which gas species that can cause an exothermic reaction, such as oxygen and hydrogen, coexist is introduced into the gas sensor.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing a partial configuration of a vehicle system 1000;

FIG. 2 is a vertical cross-sectional view taken along an element longitudinal direction schematically showing one example of a configuration of a sensor element 101 of a gas sensor 100;

FIG. 3 is a partial cross-sectional view taken along a longitudinal direction of the gas sensor 100;

FIG. 4 is a diagram schematically showing the gas sensor 100 into which a gas in which oxygen and hydrogen coexist flows;

FIG. 5 is a diagram showing a frequency of cracking of the sensor element 101 when the gas sensor 100 is used under each of a plurality of types of gas atmospheres differing in combination of an oxygen concentration and a hydrogen concentration;

FIG. 6 is a diagram showing a change over time of a duty ratio when a heater element 72 is energized under an air atmosphere and under a mixed atmosphere of oxygen and hydrogen;

FIG. 7 is a diagram showing an operational flow of the gas sensor 100 to avoid cracking occurring due to a reaction of oxygen and hydrogen in the sensor element 101; and

FIG. 8 is a diagram schematically showing a duty ratio when a heater part 70 performs heating by energization and a change over time of a temperature of the sensor element 101 in a case where oxygen and hydrogen react in the gas sensor 100.

### DESCRIPTION OF THE PREFERRED EMBODIMENTS

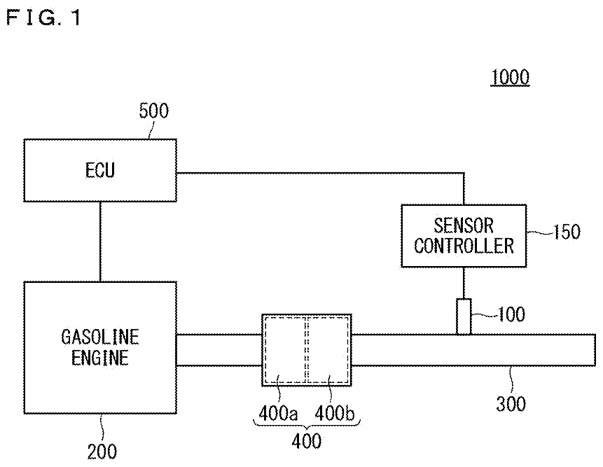

FIG. 1 is a diagram schematically showing a partial configuration of a vehicle system 1000 including a gas sensor 100 as a subject for the execution of an operating method according to the present embodiment.

The vehicle system 1000 mainly includes, in addition to the gas sensor 100, an engine 200 as a power source for an unillustrated vehicle (automobile), an exhaust pipe 300 for an exhaust gas emitted from the engine 200, a catalytic unit 400 disposed along the exhaust pipe 300, and an electronic control unit (ECU) 500 controlling operation of the vehicle system 1000, which are mounted on a body of the vehicle.

Assume that the engine 200 is used under an environment in which oxygen and hydrogen can coexist in the exhaust pipe 300 in the present embodiment. Examples of such an engine 200 include a gasoline engine and a hydrogen engine.

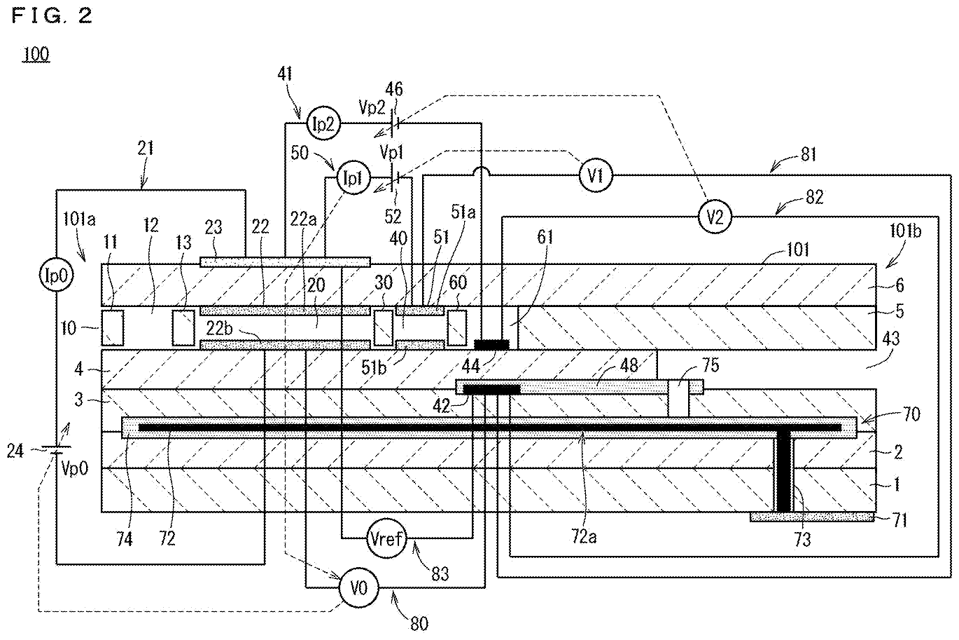

The gas sensor 100 is disposed downstream of the catalytic unit 400 along the exhaust pipe 300, detects NOx and NH₃ in the exhaust gas having passed through the catalytic unit 400 after being emitted from the engine 200, and identifies concentrations of NOx and NH₃. The gas sensor 100 includes a sensor element 101 (see FIG. 2), which will be described below. The gas sensor 100 is connected to the ECU 500 via a sensor controller 150, and the ECU 500 calculates integral values over time of the concentrations of NOx and NH₃ measured on a moment-to-moment basis to determine the amount of emitted NOx and NH₃.

In the present embodiment, the gas sensor 100, the sensor controller 150, and the ECU 500 constitute a concentration measurement apparatus that identifies a concentration of a predetermined gas component contained in a measurement gas.

The catalytic unit 400 includes a three-way catalyst (TWC) 400a and a gasoline particulate filter (GPF) 400b. While an integral configuration of the TWC 400a and GPF 400b is shown in FIG. 1, the configuration is one example, and they are sometimes provided separately. The TWC 400a mainly purifies NOx in the exhaust gas from the engine 200 in a case where the exhaust gas is a rich atmosphere indicated by an inequality λ<1, mainly purifies HC (hydrocarbons) and CO (carbon monoxide) in the exhaust gas in a case where the exhaust gas is a lean atmosphere indicated by an inequality λ>1, and purifies all of NOx, HC, and CO in the exhaust gas in a stoichiometric atmosphere near an equation λ=1. The GPF 400b is a filter that collects particulate matter (PM) contained in the exhaust gas from the engine 200. One type of the particulate matter (PM) is soot as carbon particles.

The ECU 500 is responsible for control pertaining to overall driving of the vehicle. The ECU 500 includes at least one processor (not illustrated) and at least one memory (not illustrated), and functions of the ECU 500 are performed by the processor executing software stored in the memory. The memory is a nonvolatile or volatile semiconductor memory, for example.

The sensor controller 150 is electrically connected to the gas sensor 100 and controls various drive operations for measurement of concentrations performed by the gas sensor 100 under control performed by the ECU 500. The sensor controller 150 also includes at least one processor (not illustrated) and at least one memory (not illustrated), and functions of the sensor controller 150 are performed by the processor executing software stored in the memory. The memory is a nonvolatile or volatile semiconductor memory, for example.

Sensor controllers 150 unique to individual gas sensors 100 are prepared during manufacture of the gas sensors 100 and are connected to the gas sensors 100. Characteristic information pieces unique to the individual gas sensors 100 are stored in memories of the sensor controllers 150 connected to the gas sensors 100 as will be described below.

### <General Configuration of Sensor Element>

FIG. 2 is a vertical cross-sectional view taken along an element longitudinal direction schematically showing one example of a configuration of the sensor element 101 of the gas sensor 100.

Generally speaking, in the sensor element 101, a test gas introduced into internal spaces is reduced or decomposed in the internal spaces to generate oxygen ions. Based on proportionality between the amount of oxygen ions flowing through the element and a concentration of a gas component in the test gas, the gas sensor 100 determines the concentration of the gas component. That is to say, the gas sensor 100 is a limiting current type gas sensor.

The sensor element 101 is a planar (an elongated planar) element body of ceramics having a structure in which six solid electrolyte layers, namely, a first substrate layer 1, a second substrate layer 2, a third substrate layer 3, a first solid electrolyte layer 4, a spacer layer 5, and a second solid electrolyte layer 6 each formed of zirconia (ZrO₂) (e.g., yttria stabilized zirconia (YSZ)) as an oxygen-ion conductive solid electrolyte are laminated in the stated order from a bottom side of FIG. 2. The solid electrolyte forming these six layers is dense and airtight. A surface on an upper side and a surface on a lower side of each of these six layers in FIG. 2 are hereinafter also simply referred to as an upper surface and a lower surface, respectively. A part of the sensor element 101 formed of the solid electrolyte as a whole is generically referred to as a base part.

The sensor element 101 is manufactured, for example, by performing predetermined processing, printing of circuit patterns (e.g., an electrode, an electrode lead, and a lead insulating layer), and the like on ceramic green sheets corresponding to the respective layers, then laminating them, and further firing them for integration.

Between a lower surface of the second solid electrolyte layer 6 and an upper surface of the first solid electrolyte layer 4 on a side of a first leading end portion 101a of the sensor element 101, a first diffusion control part 11 doubling as a gas inlet 10, a buffer space 12, a second diffusion control part 13, a first internal space 20, a third diffusion control part 30, a second internal space 40, a fourth diffusion control part 60, and a third internal space 61 are formed adjacent to each other to communicate in the stated order.

The buffer space 12, the first internal space 20, the second internal space 40, and the third internal space 61 are spaces (regions) inside the sensor element 101 looking as if they were provided by hollowing out the spacer layer 5, and having an upper portion, a lower portion, and a side portion respectively defined by the lower surface of the second solid electrolyte layer 6, the upper surface of the first solid electrolyte layer 4, and a side surface of the spacer layer 5. The gas inlet 10 may similarly look as if it was provided by hollowing out the spacer layer 5 in the first leading end portion 101a separately from the first diffusion control part 11. In this case, the first diffusion control part 11 is formed inside and adjacent to the gas inlet 10.

The first diffusion control part 11, the second diffusion control part 13, the third diffusion control part 30, and the fourth diffusion control part 60 are each provided as two horizontally long slits (whose openings have longitudinal directions perpendicular to the page of FIG. 2). A part extending from the gas inlet 10 to the third internal space 61 as the farthest internal space is also referred to as a gas distribution part.

On a side of a second leading end portion 101b of the sensor element 101, a reference gas introduction space 43 having a side portion defined by a side surface of the first solid electrolyte layer 4 is provided between an upper surface of the third substrate layer 3 and a lower surface of the spacer layer 5.

An air introduction layer 48 is a layer formed of porous alumina, and a reference gas is introduced into the air introduction layer 48 through the reference gas introduction space 43. The air introduction layer 48 is formed to cover a reference electrode 42.

The reference electrode 42 is an electrode formed to be sandwiched between the upper surface of the third substrate layer 3 and the first solid electrolyte layer 4, and the air introduction layer 48 leading to the reference gas introduction space 43 is provided around the reference electrode 42 as described above. As will be described below, an oxygen concentration (oxygen partial pressure) in the first internal space 20 and the second internal space 40 can be measured using the reference electrode 42.

In the gas distribution part, the gas inlet 10 (first diffusion control part 11) is a part opening to an external space, and the measurement gas is taken from the external space into the sensor element 101 through the gas inlet 10.

The first diffusion control part 11 is a part providing predetermined diffusion resistance to the taken measurement gas.

The buffer space 12 is a space provided to guide the measurement gas introduced through the first diffusion control part 11 to the second diffusion control part 13.

The second diffusion control part 13 is a part providing predetermined diffusion resistance to the measurement gas introduced from the buffer space 12 into the first internal space 20.

In introducing the measurement gas from outside the sensor element 101 into the first internal space 20, the measurement gas having abruptly been taken into the sensor element 101 through the gas inlet 10 due to pressure fluctuations (pulsation of exhaust pressure in a case where the measurement gas is an exhaust gas of a vehicle) of the measurement gas in the external space is not directly introduced into the first internal space 20 but is introduced into the first internal space 20 after concentration fluctuations of the measurement gas are canceled through the first diffusion control part 11, the buffer space 12, and the second diffusion control part 13. This makes the concentration fluctuations of the measurement gas introduced into the first internal space 20 almost negligible.

The first internal space 20 is provided as a space to adjust an oxygen concentration (oxygen partial pressure) of the measurement gas introduced through the second diffusion control part 13. The oxygen partial pressure is adjusted by operation of a main pump cell 21.

The main pump cell 21 is an electrochemical pump cell including an inner pump electrode (also referred to as a main pump electrode) 22, an outer (out-of-space) pump electrode 23, and the second solid electrolyte layer 6 sandwiched between these electrodes. The inner pump electrode 22 has a ceiling electrode portion 22a provided on substantially the entire lower surface of a portion of the second solid electrolyte layer 6 facing the first internal space 20, and the outer pump electrode 23 is provided in a region, on an upper surface of the second solid electrolyte layer 6 (one main surface of the sensor element 101), corresponding to the ceiling electrode portion 22a to be exposed to the external space.

The inner pump electrode 22 is formed on upper and lower solid electrolyte layers (the second solid electrolyte layer 6 and the first solid electrolyte layer 4) defining the first internal space 20. Specifically, the ceiling electrode portion 22a is formed on the lower surface of the second solid electrolyte layer 6, which provides a ceiling surface to the first internal space 20, and a bottom electrode portion 22b is formed on the upper surface of the first solid electrolyte layer 4, which provides a bottom surface to the first internal space 20. The ceiling electrode portion 22a and the bottom electrode portion 22b are connected by a conducting portion (not illustrated) provided on a side wall surface (an inner surface) of the spacer layer 5 forming opposite side wall portions of the first internal space 20.

The ceiling electrode portion 22a and the bottom electrode portion 22b are provided to be rectangular in plan view. Only the ceiling electrode portion 22a or only the bottom electrode portion 22b may be provided.

The inner pump electrode 22 and the outer pump electrode 23 are each formed as a porous cermet electrode. In particular, the inner pump electrode 22 to be in contact with the measurement gas is formed using a material having an ability to oxidize NH₃ while having a weakened ability to reduce a NOx component in the measurement gas. In a case where the measurement gas contains NH₃, NH₃ is oxidized by a catalytic capability of the inner pump electrode 22 and converted into NO.

For example, the inner pump electrode 22 is formed as a cermet electrode of an Au—Pt alloy containing Au of approximately 0.6 wt % to 1.4 wt % and ZrO₂ to have a porosity of 5% to 40% and a thickness of 5 μm to 20 μm. A weight ratio Pt:ZrO₂ of the Au—Pt alloy and ZrO₂ is only required to be approximately 7.0:3.0 to 5.0:5.0.

On the other hand, the outer pump electrode 23 is formed, for example, as a cermet electrode of Pt or an alloy thereof and ZrO₂ to be rectangular in plan view.

Although not illustrated in FIG. 2, an electrode protective layer covering the outer pump electrode 23 may be provided on a side of the one main surface of the sensor element 101 to protect the outer pump electrode 23.

The main pump cell 21 can pump out oxygen in the first internal space 20 to the external space or pump in oxygen in the external space to the first internal space 20 by applying a desired pump voltage Vp0 across the inner pump electrode 22 and the outer pump electrode 23 from a variable power supply 24 to allow a main pump current Ip0 to flow between the inner pump electrode 22 and the outer pump electrode 23 in a positive or negative direction under control performed by the ECU 500. The pump voltage Vp0 applied across the inner pump electrode 22 and the outer pump electrode 23 of the main pump cell 21 is also referred to as a main pump voltage Vp0.

To detect the oxygen concentration (oxygen partial pressure) in an atmosphere in the first internal space 20, the inner pump electrode 22, the second solid electrolyte layer 6, the spacer layer 5, the first solid electrolyte layer 4, the third substrate layer 3, and the reference electrode 42 constitute a main sensor cell 80 as an electrochemical sensor cell.

The oxygen concentration (oxygen partial pressure) in the first internal space 20 can be known by measuring electromotive force V0 as a potential difference between the inner pump electrode 22 and the reference electrode 42 in the main sensor cell 80.

Furthermore, the sensor controller 150 performs feedback control of the main pump voltage Vp0 so that the electromotive force V0 is constant, thereby to control the main pump current Ip0. The oxygen concentration in the first internal space 20 is thereby maintained at a predetermined constant value.

The third diffusion control part 30 is a part providing predetermined diffusion resistance to the measurement gas having an oxygen concentration (oxygen partial pressure) controlled by operation of the main pump cell 21 in the first internal space 20 and guiding the measurement gas to the second internal space 40.

The second internal space 40 is provided as a space to further adjust the oxygen partial pressure of the measurement gas introduced through the third diffusion control part 30. The oxygen partial pressure is adjusted by operation of an auxiliary pump cell 50. The oxygen concentration of the measurement gas is adjusted with higher accuracy in the second internal space 40.

After the oxygen concentration (oxygen partial pressure) is adjusted in advance in the first internal space 20, the auxiliary pump cell 50 further adjusts the oxygen concentration (oxygen partial pressure) of the measurement gas introduced through the third diffusion control part 30 in the second internal space 40.

The auxiliary pump cell 50 is an auxiliary electrochemical pump cell including an auxiliary pump electrode 51, the outer pump electrode 23 (not limited to the outer pump electrode 23 and only required to be any appropriate electrode outside the sensor element 101), and the second solid electrolyte layer 6. The auxiliary pump electrode 51 has a ceiling electrode portion 51a provided on substantially the entire lower surface of a portion of the second solid electrolyte layer 6 facing the second internal space 40.

The auxiliary pump electrode 51 is provided in the second internal space 40 in a similar form to the inner pump electrode 22 provided in the first internal space 20 described previously. That is to say, the ceiling electrode portion 51a is formed on the second solid electrolyte layer 6, which provides a ceiling surface to the second internal space 40, and a bottom electrode portion 51b is formed on the first solid electrolyte layer 4, which provides a bottom surface to the second internal space 40. The ceiling electrode portion 51a and the bottom electrode portion 51b are rectangular in plan view and are connected by a conducting portion (not illustrated) provided on the side wall surface (inner surface) of the spacer layer 5 forming opposite side wall portions of the second internal space 40.

As with the inner pump electrode 22, the auxiliary pump electrode 51 is formed using a material having a weakened ability to reduce the NOx component in the measurement gas. Alternatively, the auxiliary pump electrode 51 may be formed using a material further having an ability to oxidize NH₃. In this case, NH₃ can more surely be oxidized and converted into NO even if NH₃ not oxidized by the catalytic capability of the inner pump electrode 22 in the first internal space 20 remains in the measurement gas having reached the second internal space 40.

The auxiliary pump cell 50 can pump out oxygen in an atmosphere in the second internal space 40 to the external space or pump in oxygen in the external space to the second internal space 40 by applying a desired voltage (an auxiliary pump voltage) Vp1 across the auxiliary pump electrode 51 and the outer pump electrode 23 under control performed by the sensor controller 150.

To control the oxygen partial pressure in the atmosphere in the second internal space 40, the auxiliary pump electrode 51, the reference electrode 42, the second solid electrolyte layer 6, the spacer layer 5, the first solid electrolyte layer 4, and the third substrate layer 3 constitute an auxiliary sensor cell 81 as an electrochemical sensor cell. In the auxiliary sensor cell 81, electromotive force V1 as a potential difference caused between the auxiliary pump electrode 51 and the reference electrode 42 in accordance with the oxygen partial pressure in the second internal space 40 is detected.

The auxiliary pump cell 50 performs pumping using a variable power supply 52 whose voltage is controlled based on the electromotive force V1 detected in the auxiliary sensor cell 81. The oxygen partial pressure in the atmosphere in the second internal space 40 is thereby feedback controlled to a low partial pressure having substantially no effect on measurement of NOx.

At the same time, a resulting auxiliary pump current Ip1 is used to control the electromotive force in the main sensor cell 80. Specifically, the auxiliary pump current Ip1 is input, as a control signal, into the main sensor cell 80, and, through control of the electromotive force V0 therein, the oxygen partial pressure of the measurement gas introduced through the third diffusion control part 30 into the second internal space 40 is controlled to have a gradient that is always constant. In use as the NOx sensor, the oxygen concentration in the second internal space 40 is maintained at a constant value of approximately 0.001 ppm by the action of the main pump cell 21 and the auxiliary pump cell 50.

The fourth diffusion control part 60 is a part providing predetermined diffusion resistance to the measurement gas having an oxygen concentration (oxygen partial pressure) controlled by operation of the auxiliary pump cell 50 in the second internal space 40 and guiding the measurement gas to the third internal space 61.

The third internal space 61 is provided as a space (measurement internal space) to perform processing pertaining to measurement of a concentration of nitrogen oxide in the measurement gas introduced through the fourth diffusion control part 60. Nitrogen oxide herein includes NOx originally contained in the measurement gas and NO generated by oxidation of NH₃ contained in the measurement gas. The concentration of nitrogen oxide is measured by operation of a measurement pump cell 41 in the third internal space 61. The measurement gas having the oxygen concentration adjusted with high accuracy in the second internal space 40 is introduced into the third internal space 61, so that the gas sensor 100 can measure the concentration of nitrogen oxide with high accuracy.

The measurement pump cell 41 is to measure the concentration of nitrogen oxide in the measurement gas introduced into the third internal space 61. The measurement pump cell 41 is an electrochemical pump cell including a measurement electrode 44, the outer pump electrode 23, the second solid electrolyte layer 6, the spacer layer 5, and the first solid electrolyte layer 4. The measurement electrode 44 is provided on an upper surface of a portion of the first solid electrolyte layer 4 facing the third internal space 61 to be separated from the third diffusion control part 30.

The measurement electrode 44 is a porous cermet electrode of a noble metal and a solid electrolyte. For example, the measurement electrode 44 is formed as a cermet electrode of Pt or an alloy of Pt and another noble metal, such as Rh, and ZrO₂ as a constituent material for the sensor element 101. The measurement electrode 44 also functions as a nitrogen oxide reduction catalyst to reduce nitrogen oxide present in an atmosphere in the third internal space 61.

The measurement pump cell 41 can pump out oxygen generated by decomposition of nitrogen oxide in the atmosphere in the third internal space 61 and detect the amount of generated oxygen as a pump current (measurement pump current) Ip2 under control performed by the sensor controller 150.

To detect the oxygen partial pressure around the measurement electrode 44, the second solid electrolyte layer 6, the spacer layer 5, the first solid electrolyte layer 4, the third substrate layer 3, the measurement electrode 44, and the reference electrode 42 constitute a measurement sensor cell 82 as an electrochemical sensor cell. A variable power supply 46 is feedback-controlled based on electromotive force V2 as a potential difference caused between the measurement electrode 44 and the reference electrode 42 in accordance with the oxygen partial pressure in the third internal space 61 detected by the measurement sensor cell 82. The measurement pump cell 41 can also pump in oxygen from outside depending on setting of the electromotive force V2.

Nitrogen oxide in the measurement gas introduced into the third internal space 61 is reduced by the measurement electrode 44 to generate oxygen. Oxygen as generated is to be pumped by the measurement pump cell 41, and, in this case, a voltage (measurement pump voltage) Vp2 of the variable power supply 46 is controlled so that the electromotive force V2 detected by the measurement sensor cell 82 is constant. The amount of oxygen generated around the measurement electrode 44 is proportional to the concentration of nitrogen oxide in the measurement gas, and thus the concentration of nitrogen oxide in the measurement gas is to be calculated using the pump current (measurement pump current) Ip2 in the measurement pump cell 41.

By calculation of the concentration of nitrogen oxide in this manner alone, however, whether a value thereof corresponds to a concentration of NOx contained in the measurement gas as the lean atmosphere or corresponds to a concentration of NO generated by oxidation of NH₃ contained in the measurement gas as the rich atmosphere is not known. It is necessary to determine whether a gas component whose concentration value is to be calculated is NOx or NH₃, in order to know the amount of emitted NOx and the amount of emitted NH₃ discriminately.

In the vehicle system 1000 according to the present embodiment, determination is made not by directly detecting NOx and NH₃ but by using an atmosphere determination cell 83 of the sensor element 101.

The atmosphere determination cell 83 is an electrochemical sensor cell including the second solid electrolyte layer 6, the spacer layer 5, the first solid electrolyte layer 4, the third substrate layer 3, the outer pump electrode 23, and the reference electrode 42. Electromotive force Vref obtained by the atmosphere determination cell 83 has a value responsive to an oxygen partial pressure, that is, the amount of oxygen in an atmosphere around the sensor element 101.

In the vehicle system 1000, a value (range) of the electromotive force Vref when the measurement gas is the lean atmosphere and a value (range) of the electromotive force Vref when the measurement gas is the rich atmosphere are identified in advance and stored in an unillustrated memory of the sensor controller 150. When the gas sensor 100 performs measurement, the sensor controller 150 acquires a set of a signal indicative of a value of the measurement pump current Ip2 and a signal indicative of a value of the electromotive force Vref. Whether a value of the concentration of nitrogen oxide calculated based on the measurement pump current Ip2 is of NOx or of NH₃ is determined based on the value of the electromotive force Vref, and the value of the concentration is recorded or output as a value of a concentration of a corresponding gas species.

The sensor element 101 further includes a heater part 70 playing a role in temperature adjustment of heating the sensor element 101 and maintaining the temperature thereof to enhance oxygen ion conductivity of the solid electrolyte forming the base part.

The heater part 70 mainly includes a heater electrode 71, a heater element 72, a heater lead 72a, a through hole 73, a heater insulating layer 74, a pressure dissipation hole 75, and a heater resistance detection lead, which is not illustrated in FIG. 2. A portion of the heater part 70 other than the heater electrode 71 is buried in the base part of the sensor element 101.

The heater electrode 71 is an electrode formed to be in contact with a lower surface of the first substrate layer 1 (the other main surface of the sensor element 101).

The heater element 72 is a resistive heating element provided between the second substrate layer 2 and the third substrate layer 3. The heater element 72 generates heat by being powered from a heater power supply, which is not illustrated in FIG. 2, outside the sensor element 101 through the heater electrode 71, the through hole 73, and the heater lead 72a, which constitute an energization path. The heater element 72 is formed of Pt or contains Pt as a main component. The heater element 72 is buried, in a predetermined range of the sensor element 101 in which the gas distribution part is provided, to oppose the gas distribution part in a thickness direction of the element. The heater element 72 is provided to have a thickness of approximately 10 μm to 30 μm.

In the sensor element 101, each part of the sensor element 101 can be heated to a predetermined temperature and the temperature can be maintained by allowing a current to flow through the heater electrode 71 to the heater element 72 to thereby cause the heater element 72 to generate heat under control performed by the sensor controller 150.

In the present embodiment, the heater element 72 is energized by repeating ON/OFF periodically. A ratio of ON to one period of ON/OFF (ratio of an actual energization time) in this case is referred to as a duty ratio, and heating performed by the heater part 70 is adjusted by adjusting the duty ratio. Basically, the amount of energization of the heater element 72 increases and a degree of heating of the sensor element 101 increases with increasing duty ratio.

Specifically, the sensor element 101 is heated so that the temperature of the solid electrolyte and the electrodes in the vicinity of the gas distribution part is approximately more than 750° C. to 900° C. The oxygen ion conductivity of the solid electrolyte forming the base part of the sensor element 101 is enhanced by the heating. A heating temperature by the heater element 72 when the gas sensor 100 is in use (when the sensor element 101 is driven) is referred to as an element drive temperature.

An extent of heat generation (heater temperature) of the heater element 72 is known by the magnitude of a resistance value (heater resistance) of the heater element 72. A value of the heater resistance is provided to the sensor controller 150 and further to the ECU 500. The ECU 500 causes the sensor controller 150 to adjust the duty ratio based on the value of the heater resistance to control a temperature of the sensor element 101.

A portion on a surface of the sensor element 101 in a predetermined range from the first leading end portion 101a in the longitudinal direction may be covered with an unillustrated protective film. The protective film is provided to protect a portion in the vicinity of the first leading end portion 101a of the sensor element 101 where the internal spaces, the electrodes, and the like are provided, from thermal shock caused by wetting and the like and is also referred to as a thermal-shock-resistant protective layer. The protective film is preferably provided as a porous film formed, for example, of Al₂O₃ and having a thickness of approximately 10 μm to 2000 μm and is preferably formed to be able to withstand force of up to approximately 50 N in light of the purpose thereof.

When the gas sensor 100 having a configuration as described above measures a concentration of NOx or a concentration of NH₃, the sensor controller 150 operates the main pump cell 21 and further the auxiliary pump cell 50 to perform feedback control to make the oxygen concentration in the first internal space 20 and further the second internal space 40 constant, and the measurement gas having a constant oxygen concentration is introduced into the third internal space 61 and reaches the measurement electrode 44. In a case where the measurement gas contains NH₃, NH₃ is oxidized in the first internal space 20 or in the second internal space 40 and is converted into NO.

The measurement electrode 44 reduces nitrogen oxide in the reaching measurement gas to generate oxygen. While oxygen is pumped out by the measurement pump cell 41, the measurement pump current Ip2 flowing during pumping out has a predetermined functional relationship (hereinafter referred to as sensitivity characteristics) with the concentration of nitrogen oxide in the measurement gas.

The sensitivity characteristics are identified in advance prior to practical use of the gas sensor 100 using a plurality of types of model gases having known concentrations of nitrogen oxide, and data thereof is stored in the memory of the sensor controller 150. As described above, the value (range) of the electromotive force Vref generated by the atmosphere determination cell 83 corresponding to each of a value in a case where the measurement gas around the sensor element 101 is the lean atmosphere and a value in a case where the measurement gas around the sensor element 101 is the rich atmosphere is also stored in advance in the memory.

In practical use of the gas sensor 100, that is, when the vehicle including the vehicle system 1000 is driven, the signal representing the value of the measurement pump current Ip2 flowing in accordance with the concentration of nitrogen oxide in the measurement gas and the signal indicative of the electromotive force Vref having a value in accordance with an atmosphere of the measurement gas are provided to the sensor controller 150 on a moment-to-moment basis. These signals are provided from the sensor controller 150 to the ECU 500, and the ECU 500 successively calculates concentrations of nitrogen oxide based on the value of the measurement pump current Ip2 and the identified sensitivity characteristics. The atmosphere of the measurement gas is determined based on the value of the electromotive force Vref. A calculated concentration of nitrogen oxide is treated as that indicative of a concentration of NOx in a case where the measurement gas is determined to be the lean atmosphere and is treated as that indicative of a concentration of NH₃ in a case where the measurement gas is determined to be the rich atmosphere.

The concentration of NOx and the concentration of NH₃ in the measurement gas can thereby be known in almost real time in the vehicle system 1000 including the gas sensor 100.

### <Partial Configuration of Gas Sensor>

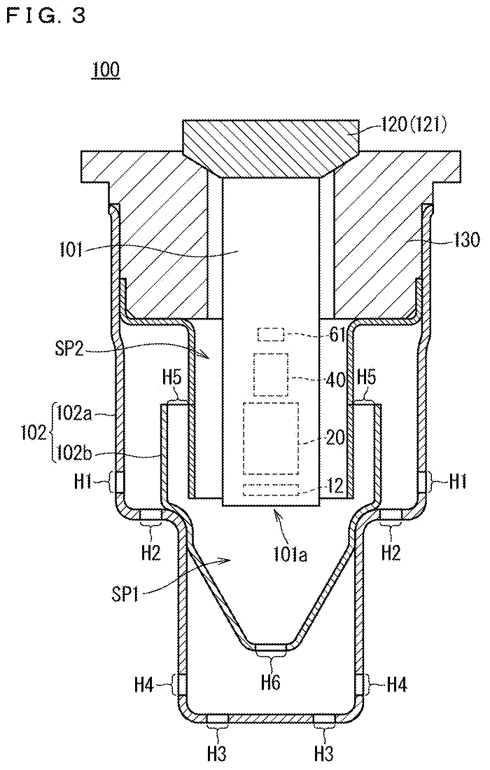

FIG. 3 is a partial cross-sectional view taken along a longitudinal direction of the gas sensor 100. Specifically, FIG. 3 is a cross-sectional view of a portion of the gas sensor 100 in the vicinity of the first leading end portion 101a of the sensor element 101. In FIG. 3, a vertical direction is indicated as a z-axis direction, and the longitudinal direction of the gas sensor 100 matches the z-axis direction. A plan view of the sensor element 101 in the thickness direction of the element is illustrated.

The gas sensor 100 mainly includes the sensor element 101, a protective cover 102 protecting the vicinity of the first leading end portion 101a, an annularly-mounted component 120 annularly mounted around the sensor element 101, and a tubular body 130 further annularly mounted around the annularly-mounted component 120 and containing the annularly-mounted component 120.

In other words, the gas sensor 100 generally has a configuration in which the sensor element 101 penetrates the tubular body 130 in an axial direction at a location of an axial center in the tubular body 130, and the annularly-mounted component 120 is annularly mounted around the sensor element 101 in the tubular body 130.

The sensor element 101 is disposed on a central axis along a longitudinal direction of the tubular body 130. A direction of extension of the central axis matching the longitudinal direction of the tubular body 130 is hereinafter also referred to as an axial direction. In FIG. 3, the axial direction matches the z-axis direction.

The protective cover 102 is a substantially cylindrical exterior member that protects the first leading end portion 101a as a portion of the sensor element 101 to be in direct contact with the test gas during use. The protective cover 102 is fixed to an outer peripheral end portion on a lower side in FIG. 3 (a negative side in the z-axis direction) of the tubular body 130 by welding.

In a case illustrated in FIG. 3, the protective cover 102 has a two-layer structure of an outer cover 102a and an inner cover 102b. The outer cover 102a and the inner cover 102b respectively have a plurality of through holes H1, H2, H3, and H4 and a plurality of through holes H5 and H6 allowing a gas to pass therethrough. The types, the numbers, the locations, the shapes, and the like of the through holes illustrated in FIG. 3 are just examples and may be determined as appropriate in view of an in-flow manner of the measurement gas into the protective cover 102.

A space between the first leading end portion 101a of the sensor element 101 and the inner cover 102b is hereinafter referred to as a first space SP1, and a space surrounded by the inner cover 102b around four side surfaces extending in the axial direction of the sensor element 101 is hereinafter referred to as a second space SP2.

The annularly-mounted component 120 includes a plurality of ceramic supporters as an insulator formed of ceramics and at least one powder compact formed by molding powder of ceramics, such as talc, and interposed between the ceramic supporters. While only one ceramic supporter 121 is illustrated as the annularly-mounted component 120 for illustration purposes in FIG. 3, a space which is enclosed by the ceramic supporters and the tubular body 130 and through which the sensor element 101 penetrates is densely compression filled with ceramic particles constituting the powder compact. In the gas sensor 100, airtight sealing between a side of the first leading end portion 101a and a side of the second leading end portion 101b of the sensor element 101 is implemented due to compression filling with the powder compact.

The tubular body 130 is a tubular member of metal also referred to as a main metal fitting. The sensor element 101 and the annularly-mounted component 120 are contained and fixed in the tubular body 130. In other words, the tubular body 130 is further annularly mounted around the annularly-mounted component 120 annularly mounted around the sensor element 101. However, only a portion of the tubular body 130 is illustrated in FIG. 3 for illustration purposes.

Although not illustrated in FIG. 3, an outer peripheral portion of a portion of the tubular body 130 is a threaded bolt portion. The bolt portion is used when the gas sensor 100 is fixed to a measurement location, such as the exhaust pipe 300.

Furthermore, an unillustrated outer tube is fixed to an outer peripheral end portion on an upper side (a positive side in the z-axis direction) of the tubular body 130 by welding. A connector to electrically connect the sensor element 101 and an outside is disposed in the outer tube. A seal (sealing) member is fit into an upper end of the outer tube. In the gas sensor 100, a space surrounded by the outer tube between the tubular body 130 and the seal member is thus a reference gas space into which the second leading end portion 101b of the sensor element 101 protrudes. As a reference gas when the concentration of NOx is measured, air is introduced into the reference gas space, for example. The reference gas is introduced from the reference gas space into the reference gas introduction space 43 of the sensor element 101.

### <Use in Presence of Oxygen and Hydrogen>

Operation in a case where the gas sensor 100 having a configuration as described above is used in the presence of oxygen and hydrogen will be described next. More specifically, it will be described about temperature control of the sensor element 101 in a case where the measurement gas in which oxygen and hydrogen may coexist is measured using the gas sensor 100 having a configuration in which an end portion (the first leading end portion 101a) of the sensor element 101 on a side of the heater element 72 protrudes into the protective cover 102 into which the measurement gas is introduced.

When the gas sensor 100 is in use, the sensor element 101 is heated by the heater part 70, and therefore, the measurement gas reaching the vicinity of the sensor element 101 is also heated to a high temperature. Thus, in a case where oxygen and hydrogen coexist in the measurement gas, they can react depending on a condition.

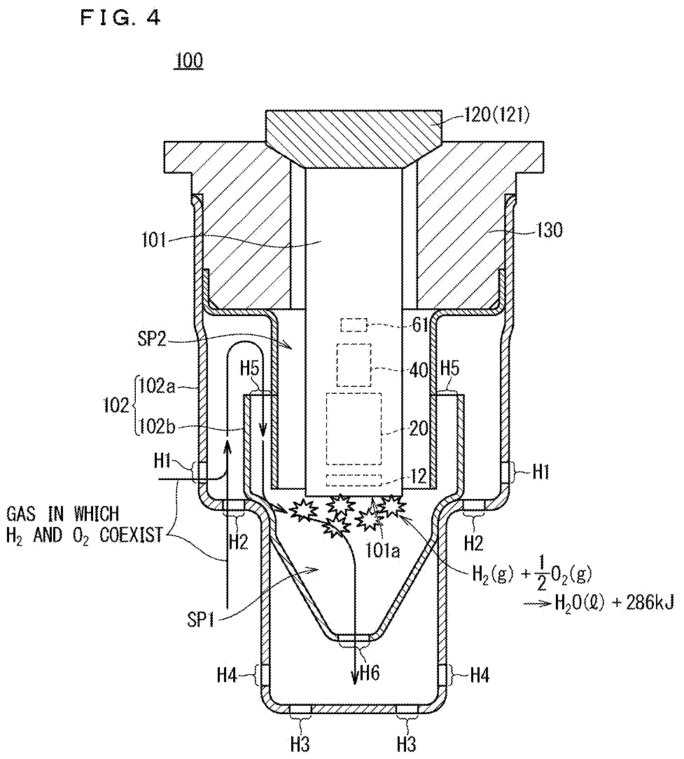

FIG. 4 is a diagram schematically showing a flow of a gas in which oxygen and hydrogen coexist into the gas sensor 100 having the configuration illustrated in FIG. 3. FIG. 4 illustrates a case where the gas in which oxygen and hydrogen coexist flows in through the through holes H1 and H2 of the outer cover 102a, further flows into the inner cover 102b (in particular into the first space SP1) through the through holes H5, and flows out through the through hole H6 and further through the through holes H3 or H4 of the outer cover 102a. Oxygen pumped out from inside the sensor element 101 is also emitted toward the second space SP2 in the inner cover 102b.

The heater element 72 of the heater part 70 is provided in a predetermined range on a side of the first leading end portion 101a in which the gas distribution part including the first internal space 20, the second internal space 40, the third internal space 61, and the like is present, so that a portion in the vicinity of the first leasing end portion 101a is at the highest temperature in the inner cover 102b when the gas sensor 100 is operated. It is thus considered that oxygen and hydrogen flowing into the inner cover 102b are most likely to react in the vicinity of the first leading end portion 101a in the first space SP1.

The reaction is an exothermic reaction accompanied by heat generation of 284 kJ per mole of generated vapor, so that a rapid reaction of oxygen and hydrogen can cause cracking of the sensor element 101 due to thermal stress caused by the reaction. Assume that cracking of the sensor element 101 includes cracking of the unillustrated protective film provided around the first leading end portion 101a in the present embodiment.

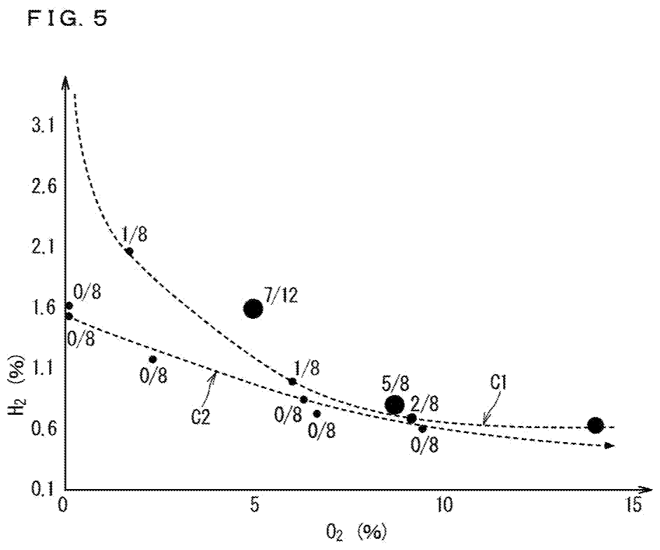

FIG. 5 is a diagram showing a frequency of cracking of the sensor element 101 when a plurality of types of gases differing in combination of the concentration of oxygen and the concentration of hydrogen were prepared and the gas sensor 100 was used under each gas atmosphere. Specifically, 8 or 12 gas sensors 100 were prepared for each gas species and were driven, and a rate of occurrence of cracking of the sensor element 101 under each gas species atmosphere is plotted in FIG. 5 with a horizontal axis representing the concentration of oxygen (O₂) and a vertical axis representing the concentration of hydrogen (H₂). A balance of each gas was N₂, and the element drive temperature was 840° C.

It can be seen from FIG. 5 that, while cracking of some sensor elements 101 occurred in a concentration range above a curve C1, cracking of no sensor elements 101 occurred in a concentration range below a curve C2. This suggests that cracking occurring due to the reaction of oxygen and hydrogen can be prevented as long as the concentration of oxygen and the concentration of hydrogen are in the concentration range below the curve C2 even when the gas sensor 100 is used under a condition in which oxygen and hydrogen coexist.

Table 1 shows a relationship between an atmospheric temperature and how likely cracking of the sensor element 101 is to occur. The atmospheric temperature was at six different levels of 500° C., 600° C., 700° C., 750° C., 800° C., and 840° C. Table 1 shows, as a list, the number of gas sensors 100 in which cracking of the sensor element 101 did not occur and the number of gas sensors 100 in which cracking of the sensor element 101 occurred at each atmospheric temperature when 8 gas sensors 100 were each exposed to a gas atmosphere containing 5% of oxygen and 1.8% of hydrogen and having a balance of N₂ for 100 seconds. The gas atmosphere as used was an atmosphere located above the curve C1 in a result of plotting of the rate of occurrence of cracking shown in FIG. 5.

TABLE 1

| ELEMENT | | |
|---|---|---|
| TEMPER- | NUMBER OF SENSORS | NUMBER OF SENSORS |
| ATURE | IN WHICH CRACKING | IN WHICH CRAKING |
| ° C. | DID NOT OCCUR | OCCURRED |
| 500 | 8 | 0 |
| 600 | 8 | 0 |
| 700 | 8 | 0 |
| 750 | 8 | 0 |
| 800 | 4 | 4 |
| 840 | 4 | 4 |

As shown in Table 1, cracking of the sensor element 101 occurred at an atmospheric temperature of 800° C. or more, whereas cracking of the sensor element 101 did not occur at an atmospheric temperature of 750° C. or less.

This means that, even in the gas sensor in which cracking of the sensor element 101 is likely to occur due to the reaction of oxygen and hydrogen as long as the sensor element 101 is maintained at the predetermined element drive temperature, cracking can be prevented in a case where the heating temperature of the sensor element 101 by the heater part 70 is reduced to suppress an increase in atmospheric temperature.

In practical use of the gas sensor 100, however, the concentration of oxygen and the concentration of hydrogen in the measurement gas may change on a moment-to-moment basis. That is to say, in a case where oxygen and hydrogen coexist in the measurement gas flowing into the first space SP, how likely they are to react always changes during operation of the gas sensor 100. On the other hand, excessive reduction in temperature of the sensor element 101 during operation of the gas sensor 100 leads to the occurrence of an unmeasurable time or reduction in measurement accuracy.

To avoid cracking of the sensor element 101 occurring due to the reaction of oxygen and hydrogen, early detection of the reaction and an appropriate response thereto are needed.

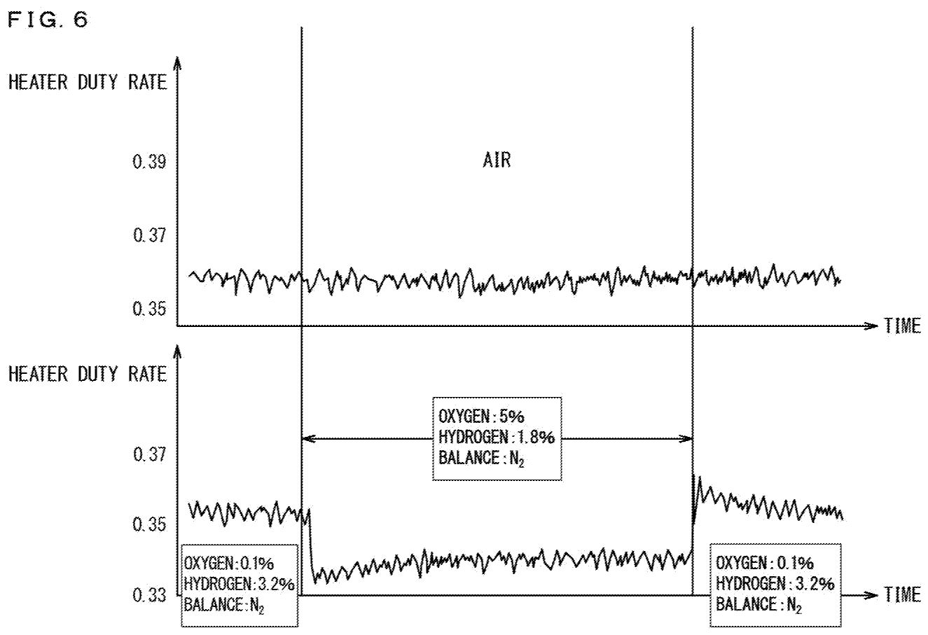

FIG. 6 is a diagram showing a duty ratio over time during energization to the heater element 72 of the heater part 70 in a case that the gas sensor 100 was driven under an air atmosphere while the element drive temperature (a set heating temperature by the heater element 72) was maintained at 840° C., and, in a case that, while the gas sensor 100 was driven under a first gas atmosphere, the first gas atmosphere was temporarily changed to a second gas atmosphere for comparison, the first gas atmosphere containing 0.1% of oxygen and 3.2% of hydrogen and having a balance of N₂, and, the second gas atmosphere containing 5% of oxygen and 1.8% of hydrogen and having a balance of N₂. The first gas atmosphere is an atmosphere located below the curve C1, and the second gas atmosphere is an atmosphere located above the curve C1 in FIG. 5.

As shown in FIG. 6, the duty ratio was almost constant in a case of drive in the air, whereas the duty ratio was temporarily reduced by 1.5% at a timing responsive to the change in a case where the first gas atmosphere was temporarily changed to the second gas atmosphere.

The duty ratio is normally to be maintained at a constant value in a case where the element drive temperature is maintained constant. Temporal reduction in duty ratio with the change in gas atmosphere despite the foregoing means that heat generation contributing to maintenance of the element drive temperature occurred with the change in addition to heating by the heater part 70, and thus, the element drive temperature could be maintained constant despite that the duty ratio during heating by energization to the heater part 70 was reduced from that before the change in gas atmosphere. The heat generation is presumably due to the reaction of oxygen and hydrogen.

In the present embodiment, such a correspondence relationship between the exothermic reaction of oxygen and hydrogen and the duty ratio during heating the sensor element 101 by energization to the heater part 70 is used to avoid cracking of the sensor element 101 occurring due to the reaction.

Generally speaking, the ECU 500 monitors the duty ratio of the sensor element 101 heated to the element drive temperature, and, when reduction in duty ratio is detected, the temperature of the sensor element 101 is temporarily reduced from a normal element drive temperature (normal drive temperature) to a temperature (protective drive temperature) at which cracking of the sensor element 101 does not occur even when oxygen and hydrogen coexisting in the measurement gas react, in order to avoid cracking occurring due to the reaction of oxygen and hydrogen. The protective drive temperature is only required to be identified experimentally prior to use of the gas sensor 100. For example, the protective drive temperature is 750° C. or less. In a case of industrially mass-produced gas sensors 100, the protective drive temperature is only required to be identified based on a relationship between the frequency of cracking and the atmospheric temperature when the gas sensor is exposed to a predetermined gas atmosphere in which oxygen and hydrogen coexist with varying the atmospheric temperature as in a case where Table 1 is obtained, for example.

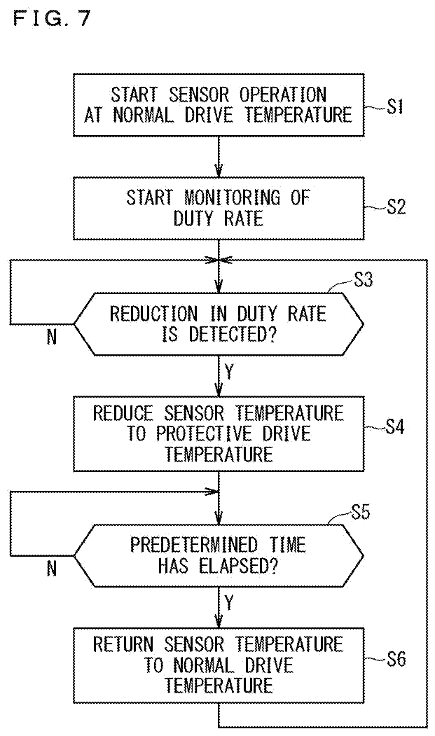

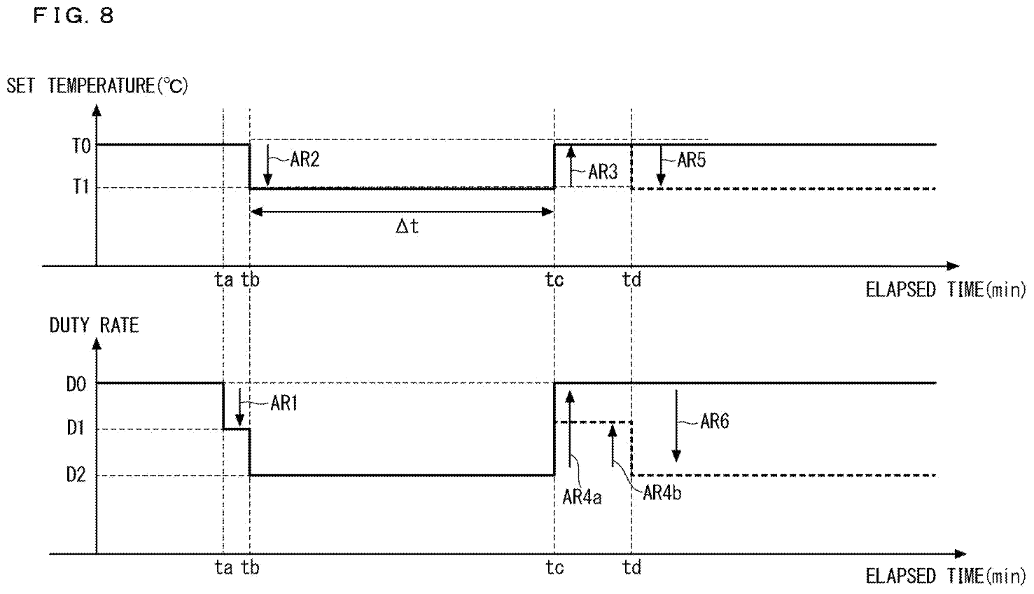

FIG. 7 is a diagram showing an operational flow of the gas sensor 100 to avoid cracking occurring due to the reaction of oxygen and hydrogen in the sensor element 101. FIG. 8 is a diagram schematically showing a change over time of the duty ratio during heating by energization to the heater part 70 and the temperature of the sensor element 101, in a case where oxygen and hydrogen react in the gas sensor 100 operating in accordance with the operational flow. In FIG. 8, the normal drive temperature is TO, and the protective drive temperature is T1.

First, the gas sensor 100 is started, and thereby, operation at the normal drive temperature is started (step S1). Specifically, the ECU 500 causes the sensor controller 150 to start drive of the sensor element 101 and heating by the heater part 70 and causes the gas sensor 100 to start measurement when the temperature of the sensor element 101 reaches the normal drive temperature. At this timing, the ECU 500 determines the temperature of the sensor element 101 based on the value of the heater resistance as described above. The gas sensor 100 starts operation to identify the concentrations of NOx and NH₃ contained in the measurement gas having reached the gas sensor 100 in the exhaust pipe 300 under control performed by the ECU 500 and the sensor controller 150. Drive of the gas sensor 100 is normally started along with a start of the vehicle system 1000.

When the gas sensor 100 starts operation at the normal drive temperature, the ECU 500 starts monitoring of the duty ratio in energization to the heater element 72 of the heater part 70, which is adjusted by the sensor controller 150 to maintain the sensor element 101 at the normal drive temperature (step S2). In a case where the duty ratio is reduced from a value (hereinafter a normal value) to maintain the normal drive temperature under a condition in which oxygen and hydrogen do not react, the reduction is detected (step S3).

Unless the ECU 500 detects reduction in monitored duty ratio from the normal value (NO in step S3), the sensor element 101 is maintained at the normal drive temperature, and normal measurement operation is continued. Continuation of a condition in which reduction in duty ratio is not detected means that oxygen and hydrogen do not react in the gas sensor 100.

In a case shown in FIG. 8, the sensor controller 150 maintains the duty ratio at the normal value D0, so that the sensor element 101 is maintained at the normal drive temperature T0.

On the other hand, when oxygen and hydrogen react due to introduction of the measurement gas containing hydrogen into the gas sensor 100, the sensor controller 150 reduces the duty ratio so as to maintain the sensor element 101 at the normal drive temperature T0 under a condition in which heat generation occurs due to the reaction. In a case shown in FIG. 8, the sensor controller 150 reduces the duty ratio to a value D1 as indicated by an arrow AR1 at time ta, while the sensor element 101 is still maintained at the normal drive temperature T0.

When reduction in monitored duty ratio is detected (YES in step S3), the ECU 500 provides the sensor controller 150 with control instructions to reduce the temperature of the sensor element 101 to the protective drive temperature. In response to the control instructions, the sensor controller 150 further reduces the duty ratio having been reduced with the exothermic reaction of oxygen and hydrogen. The temperature of the sensor element 101 is thereby reduced to the protective drive temperature (step S4).

In a case shown in FIG. 8, the sensor controller 150 reduces the duty ratio from the value D1 to a value D2 at time tb, so that the temperature of the sensor element 101 is reduced from the normal drive temperature T0 to the protective drive temperature Tl as indicated by an arrow AR2.

The sensor element 101 is maintained at the protective drive temperature, so that cracking of the sensor element 101 does not occur even under a condition in which oxygen and hydrogen contained in the measurement gas react in the gas sensor 100.

In terms of preventing the occurrence of the unmeasurable time, the protective drive temperature is preferably set as a temperature at which oxygen ion conductivity of the solid electrolyte forming the base part of the sensor element 101 is maintained to the extent that the sensor element 101 still can perform operation to identify the concentrations of NOx and NH₃. In terms of prioritizing surely preventing cracking, however, the protective drive temperature may be set to a temperature lower than such a temperature. Measurement by the gas sensor 100 is continued in the former case, but, in the latter case, measurement of the concentrations of NOx and NH₃ by the gas sensor 100 is temporarily suspended until the temperature of the sensor element 101 is returned to the normal drive temperature.

The ECU 500 monitors whether a predetermined time (protective drive time) set in advance has elapsed since reduction in temperature of the sensor element 101 to the protective drive temperature (step S5). A length of the protective drive time is set so that the reaction of oxygen and hydrogen is expected to end until the end of the protective drive time. For example, the protective drive time is set in a range of 5 minutes or more and 30 minutes or less. The sensor element 101 is maintained at the protective drive temperature until the protective drive time elapses (NO in step S5).

At a timing when the protective drive time has elapsed (YES in step S5), the ECU 500 provides the sensor controller 150 with control instructions to return the temperature of the sensor element 101 to the normal drive temperature. In response to the control instructions, the sensor controller 150 increases the duty ratio having been reduced to maintain the sensor element 101 at the protective drive temperature. The temperature of the sensor element 101 is thereby returned to the normal drive temperature (step S6). Operation in and after step S3 is then repeated.

In a case shown in FIG. 8, the temperature of the sensor element 101 is returned from the protective drive temperature Tl to the normal drive temperature T0 as indicated by an arrow AR3 at time tc at which the protective drive time Δt has elapsed since the time tb at which the duty ratio is reduced to the value D2.

In a case where oxygen and hydrogen do not react when the protective drive time has elapsed, the return to the normal drive temperature is achieved by the sensor controller 150 increasing the duty ratio to return to the normal value. This is indicated by an arrow AR4a in a case shown in FIG. 8.

In a case where oxygen and hydrogen still react even when the protective drive time has elapsed, however, reaction heat is generated due to the reaction, so that the temperature of the sensor element 101 is returned to the normal drive temperature T0 without the return of the duty ratio to the normal value by the sensor controller 150. In other words, the sensor controller 150 is not required to return the duty ratio to the normal value in the return to the normal drive temperature T0. This is indicated by an arrow AR4b in a case shown in FIG. 8.

In such a case, the ECU 500 having detected the duty ratio still lower than an original value (YES in step S3) is to provide the sensor controller 150 with the control instructions to reduce the temperature of the sensor element 101 to the protective drive temperature again.

In a case shown in FIG. 8, at the time tc at which the temperature of the sensor element 101 is returned to the normal drive temperature, the sensor controller 150 returns the duty ratio only to the value DI lower than the normal value as indicated by the arrow AR4b. The ECU 500 having detected this return provides the sensor controller 150 with the control instructions to reduce the temperature of the sensor element 101 from the normal drive temperature T0 to the protective drive temperature Tl at time td as indicated by an arrow AR5. In response to the control instructions, the sensor controller 150 reduces the duty ratio from the value DI to the value D2. As a result, the temperature of the sensor element 101 is reduced to the protective drive temperature T1.

The return to the normal drive temperature T0 and determination on whether the duty ratio in this timing is still lower than the normal value are then repeated again when the protective drive time Δt has elapsed.

As described above, the temperature of the sensor element 101 is reduced to the protective drive temperature Tl each time reduction in duty ratio occurring due to the reaction of oxygen and hydrogen is detected, so that, even when the measurement gas in which oxygen and hydrogen coexist is introduced, cracking of the sensor element 101 occurring due to thermal stress caused by the reaction of them is suitably avoided in the gas sensor 100.

As described above, in the gas sensor according to the present embodiment, it is utilized that a value of the duty ratio, which indicates the ON/OFF ratio of energization to the heater part in order to heat the sensor element and maintain the sensor element at the element drive temperature, is reduced by the exothermic reaction of oxygen and hydrogen in a case where the measurement gas in which oxygen and hydrogen coexist is introduced, so as to avoid cracking of the sensor element occurring due to thermal stress caused by the exothermic reaction.

That is to say, in a case where the duty ratio is reduced under a condition in which the drive temperature of the sensor element does not change, the temperature of the sensor element is reduced to the protective drive temperature which is lower than the normal drive temperature and at which it has been observed that cracking does not occur. The gas sensor can thus be used without undergoing cracking of the sensor element even in a case where the measurement gas in which oxygen and hydrogen coexist is to be measured.

### <Modifications>

The above-mentioned embodiment is directed to a case where the limiting current type gas sensor that introduces the measurement gas into the sensor element 101 including the base part formed of the oxygen-ion conductive solid electrolyte and identifies the concentration of nitrogen oxide based on the magnitude of the oxygen pump current flowing when the electrochemical pump cell of the sensor element 101 pumps out oxygen derived from nitrogen oxide decomposed by the measurement electrode to the outside is used in the presence of oxygen and hydrogen.

Operation of the gas sensor according to the above-mentioned embodiment, however, is applicable to a gas sensor which has a configuration in which an end portion of the sensor element on a side on which the heater element is provided protrudes into the protective cover into which the measurement gas is introduced and in which oxygen and hydrogen can coexist in the measurement gas even if the sensor element has a different internal configuration from that in the above-mentioned embodiment.

For example, operation of the gas sensor according to the above-mentioned embodiment is applicable to a mixed potential type gas sensor that identifies a concentration of a detection target gas component contained in the measurement gas based on a potential difference between a detection electrode disposed on a surface of the base part formed of the oxygen-ion conductive solid electrolyte of the sensor element and the reference electrode disposed in the sensor element if the gas sensor has a similar configuration.

While cracking of the sensor element occurring due to thermal stress caused by the reaction of oxygen and hydrogen as the exothermic reaction is to be avoided in the above-mentioned embodiment, an operating method according to the above-mentioned embodiment is applicable in a case where a similar exothermic reaction can be caused by a reaction of other gas species contained in the measurement gas.

While the invention has been shown and described in detail, the foregoing description is in all aspects illustrative and not restrictive. It is therefore understood that numerous modifications and variations can be devised without departing from the scope of the invention.

What is claimed is:

1. A gas sensor operating method of operating a gas sensor, wherein
the gas sensor comprises:
a sensor element configured to be capable of identifying a concentration of a predetermined gas component contained in a measurement gas; and
a protective cover into which the measurement gas is introduced,
the sensor element comprises:
a base part formed of an oxygen-ion conductive solid electrolyte; and
a heater part including a heater element on a side of one end portion of the sensor element and heating the sensor element by the heater element being energized according to a duty ratio,
a portion of the sensor element on a side of the one end portion protrudes into the protective cover,
the gas sensor operating method comprises:
a) causing the heater part to heat the sensor element to a predetermined normal drive temperature and putting the gas sensor into a drive state in which the predetermined gas component is measurable;
b) monitoring the duty ratio for use in the heater part; and
c) controlling a temperature of the sensor element based on the temperature of the sensor element and a value of the duty ratio obtained in the step b), and
in the step c),
when reduction of the duty ratio from a normal value corresponding to the normal drive temperature is detected in the step b) with the sensor element being at the normal drive temperature, the duty ratio is further reduced to reduce the temperature of the sensor element to a predetermined protective drive temperature,
the duty ratio is increased at a timing when a predetermined protective drive time has elapsed after reduction of the temperature of the sensor element to the protective drive temperature, thereby to return the temperature of the sensor element from the protective drive temperature to the normal drive temperature, and
when the duty ratio at a timing when the temperature of the sensor element is returned to the normal drive temperature is smaller than the normal value, the duty ratio is reduced again to reduce the temperature of the sensor element to the protective drive temperature.

2. The gas sensor operating method according to claim 1, wherein
the protective drive temperature is a temperature identified in advance at which cracking of the sensor element does not occur due to thermal stress caused by a reaction of oxygen and hydrogen contained in the measurement gas.

3. The gas sensor operating method according to claim 2, wherein
the normal drive temperature is more than 750° C. to 900° C., and
the protective drive temperature is 750° C. or less.

4. The gas sensor operating method according to claim 1, wherein
the gas sensor is a limiting current type gas sensor, and
the sensor element further comprises:
a gas inlet which is provided in the one end portion and through which the measurement gas is introduced;
a measurement internal space communicating with the gas inlet via a diffusion control part; and
a measurement pump cell including a measurement electrode disposed in the measurement internal space, an out-of-space pump electrode disposed at a location other than the measurement internal space, and a portion of the solid electrolyte present between the measurement electrode and the out-of-space pump electrode.

5. A concentration measurement apparatus comprising:
a gas sensor configured to be capable of identifying a concentration of a predetermined gas component contained in a measurement gas; and
a control element, wherein
the gas sensor comprises:
a sensor element configured to be capable of identifying the concentration of the predetermined gas component contained in the measurement gas;
a protective cover into which the measurement gas is introduced; and
a sensor controller controlling operation of the sensor element,
the sensor element comprises:
a base part formed of an oxygen-ion conductive solid electrolyte; and
a heater part including a heater element on a side of one end portion of the sensor element and heating the sensor element by the heater element being energized according to a duty ratio set by the sensor controller based on control performed by the control element,
a portion of the sensor element on a side of the one end portion protrudes into the protective cover,
the control element is configured to
cause the sensor controller to cause the heater part to heat the sensor element to a predetermined normal drive temperature and to put the gas sensor into a state in which the predetermined gas component is measurable;
monitor the duty ratio for use in the heater part set by the sensor controller; and
cause the sensor controller to control a temperature of the sensor element based on the temperature of the sensor element and a value of the monitored duty ratio,
when reduction of the duty ratio from a normal value corresponding to the normal drive temperature is detected with the sensor element being at the normal drive temperature, the sensor controller is caused to further reduce the duty ratio to reduce the temperature of the sensor element to a predetermined protective drive temperature,
the sensor controller is caused to increase the duty ratio at a timing when a predetermined protective drive time has elapsed after reduction of the temperature of the sensor element to the protective drive temperature, thereby to return the temperature of the sensor element from the protective drive temperature to the normal drive temperature, and
when the duty ratio at a timing when the temperature of the sensor element is returned to the normal drive temperature is smaller than the normal value, the sensor controller is caused to reduce the duty ratio again to reduce the temperature of the sensor element to the protective drive temperature.

6. The concentration measurement apparatus according to claim 5, wherein
the protective drive temperature is a temperature at which cracking of the sensor element does not occur due to thermal stress caused by a reaction of oxygen and hydrogen contained in the measurement gas.

7. The concentration measurement apparatus according to claim 6, wherein
the normal drive temperature is more than 750° C. to 900° C., and
the protective drive temperature is 750° C. or less.

8. The concentration measurement apparatus according to claim 5, wherein
the gas sensor is a limiting current type gas sensor, and
the sensor element further comprises:
a gas inlet which is provided in the one end portion and through which the measurement gas is introduced;
a measurement internal space communicating with the gas inlet via a diffusion control part; and
a measurement pump cell including a measurement electrode disposed in the measurement internal space, an out-of-space pump electrode disposed at a location other than the measurement internal space, and a portion of the solid electrolyte present between the measurement electrode and the out-of-space pump electrode.

9. The gas sensor operating method according to claim 2, wherein
the gas sensor is a limiting current type gas sensor, and
the sensor element further comprises:
a gas inlet which is provided in the one end portion and through which the measurement gas is introduced;
a measurement internal space communicating with the gas inlet via a diffusion control part; and
a measurement pump cell including a measurement electrode disposed in the measurement internal space, an out-of-space pump electrode disposed at a location other than the measurement internal space, and a portion of the solid electrolyte present between the measurement electrode and the out-of-space pump electrode.

10. The gas sensor operating method according to claim 3, wherein
the gas sensor is a limiting current type gas sensor, and
the sensor element further comprises:
a gas inlet which is provided in the one end portion and through which the measurement gas is introduced;
a measurement internal space communicating with the gas inlet via a diffusion control part; and
a measurement pump cell including a measurement electrode disposed in the measurement internal space, an out-of-space pump electrode disposed at a location other than the measurement internal space, and a portion of the solid electrolyte present between the measurement electrode and the out-of-space pump electrode.

11. The concentration measurement apparatus according to claim 6, wherein
the gas sensor is a limiting current type gas sensor, and
the sensor element further comprises:
a gas inlet which is provided in the one end portion and through which the measurement gas is introduced;
a measurement internal space communicating with the gas inlet via a diffusion control part; and
a measurement pump cell including a measurement electrode disposed in the measurement internal space, an out-of-space pump electrode disposed at a location other than the measurement internal space, and a portion of the solid electrolyte present between the measurement electrode and the out-of-space pump electrode.

12. The concentration measurement apparatus according to claim 7, wherein
the gas sensor is a limiting current type gas sensor, and
the sensor element further comprises:
a gas inlet which is provided in the one end portion and through which the measurement gas is introduced;
a measurement internal space communicating with the gas inlet via a diffusion control part; and
a measurement pump cell including a measurement electrode disposed in the measurement internal space, an out-of-space pump electrode disposed at a location other than the measurement internal space, and a portion of the solid electrolyte present between the measurement electrode and the out-of-space pump electrode.
